(19) United States
(12) Patent Application Publication
(10) Pub. No.: US 2014/0141198 A1
(43) Pub. Date: May 22, 2014

(54) CUSHIONED MAT WITH APERTURED FOAM

(71) Applicant: MOHAWK INDUSTRIES, INC., Marietta, GA (US)

(72) Inventor: Maria Paola Teran, Acworth, GA (US)

(73) Assignee: Mohawk Industries, Inc., Marietta, GA (US)

(21) Appl. No.: 13/682,478

(22) Filed: Nov. 20, 2012

(51) Int. Cl. A47G 27/02; B32B 7/12; B32B 5/02; B32B 3/26; B32B 5/24

(52) U.S. Cl. CPC A47G 27/0212; B32B 3/266; B32B 5/245; B32B 5/024; B32B 7/12
USPC 428/138; 112/440

(57) ABSTRACT

Various embodiments of the present invention are directed to a cushioned mat configured for use in environments where water may come into contact with the cushioned mat, such as in a household bathroom. According to various embodiments, the cushioned mat includes a foam layer configured to act as a cushioning material. To improve the drying performance of the mat, the foam layer is apertured. In addition, various embodiments of the cushioned mat may be provided with a surface layer of face fabric and a backing layer configured for reducing slippage of the mat against a support surface.

### BACKGROUND OF THE INVENTION

1. Field of the Invention

Various embodiments of the present invention described herein generally relate to cushioned mats for bathroom, kitchen, and other uses, and in particular to cushioned mats with enhanced drying properties.

2. Description of Related Art

Mats are often placed on bathroom and kitchen floors to absorb water and to provide a comfortable standing surface. For example, bath mats are frequently placed beside showers or bathtubs to absorb water when the user exits and dries off. In addition, such mats can also be placed in front of bathroom or kitchen sinks to absorb water that would otherwise splash on the floor. These mats may include some type of non-skid backing to create traction against a floor support surface and protect against slippage.

It is also known to add a foam cushioning layer in such mats to enhance a user's comfort when standing on a hard surface. As an example, U.S. Patent Application Publication No. 2011/0143083 to Scorgie (“the '083 application”) discloses a mat with a cushioning layer. The cushioned mat of the '083 application includes a layer of absorbent woven textile material positioned over a foam cushioning layer. The woven textile material is formed of a “quick drying” material which acts to wick moisture away from the foam cushioning layer so that the foam cushioning layer can dry out in wet or humid environments, such as bathrooms. A rubberized base material, such as one made from a sheet of styrene butadiene rubber (SBR), is glued to the underside of the foam cushioning layer.

However, there is an on-going need in the art for cushioned mats with enhanced drying properties. In particular, as the above-described cushioned mats are often washed, there is a need for a cushioned mat that will dry quickly after being saturated with water during washing. In addition, mats that become wet during use (e.g., in a bathroom) can be unpleasant to the touch and susceptible to breeding bacteria. Thus, there is a need in the art for cushioned mats that dry more quickly during use.

### BRIEF SUMMARY OF THE INVENTION

Various embodiments of the present invention are directed to a cushioned mat configured for use as a standing surface in environments where water may come into contact with the cushioned mat. According to various embodiments, the cushioned mat comprises a face fabric configured for coming into contact with a user, a backing layer operatively secured to the face fabric layer and configured for reducing slippage of the cushioned mat against a support surface, and an apertured foam layer secured to and interposed between the face fabric and the backing layer. In various embodiments, the apertured foam layer comprises a foam material having one or more apertures extending into the foam material.

In addition, according to certain embodiments, the one or more apertures comprise one or more holes having a circular cross-section. The one or more holes may have a diameter, for example, between approximately 1 mm and 6 mm. In addition, according to certain embodiments, the one or more apertures may extend through the entire thickness of the apertured foam layer and may be vertically oriented. Furthermore, according to certain embodiments, the one or more apertures comprise a plurality of apertures provided in a density between 40 apertures per square foot of the foam layer's surface area and 1,600 apertures per square foot of the foam layer's surface area.

According to various embodiments, the cushioned mat's the foam material may comprise an open cell, viscoelastic foam material, such as a viscoelastic polyurethane foam. In addition, various embodiments of the cushioned mat's backing layer may be formed with openings configured for allowing water in the foam layer to leave the mat at least partially through the openings in the backing In certain embodiments, the backing layer may comprise a sheet of woven fibers coated with a slip-resistant substance.

### BRIEF DESCRIPTION OF THE DRAWINGS

Having thus described the invention in general terms, reference will now be made to the accompanying drawings, which are not necessarily drawn to scale, and wherein:

FIG. 1 is a cross-sectional schematic view of a cushioned mat according to one embodiment of the present invention;

FIG. 2 is a top view of a foam layer according to one embodiment of the present invention;

FIG. 3 is a close-up view of a section of the porous backing according to one embodiment of the present invention; and

FIG. 4 is a bottom view of a portion of a cushioned mat according to one embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Various embodiments of the present invention are generally directed to a cushioned mat configured for use in environments where water may come into contact with the cushioned mat, such as in a household bathroom. As described in greater detail below, various embodiments of the cushioned mat include an apertured foam layer configured for improving the drying performance of the mat.

### Cushioned Mat

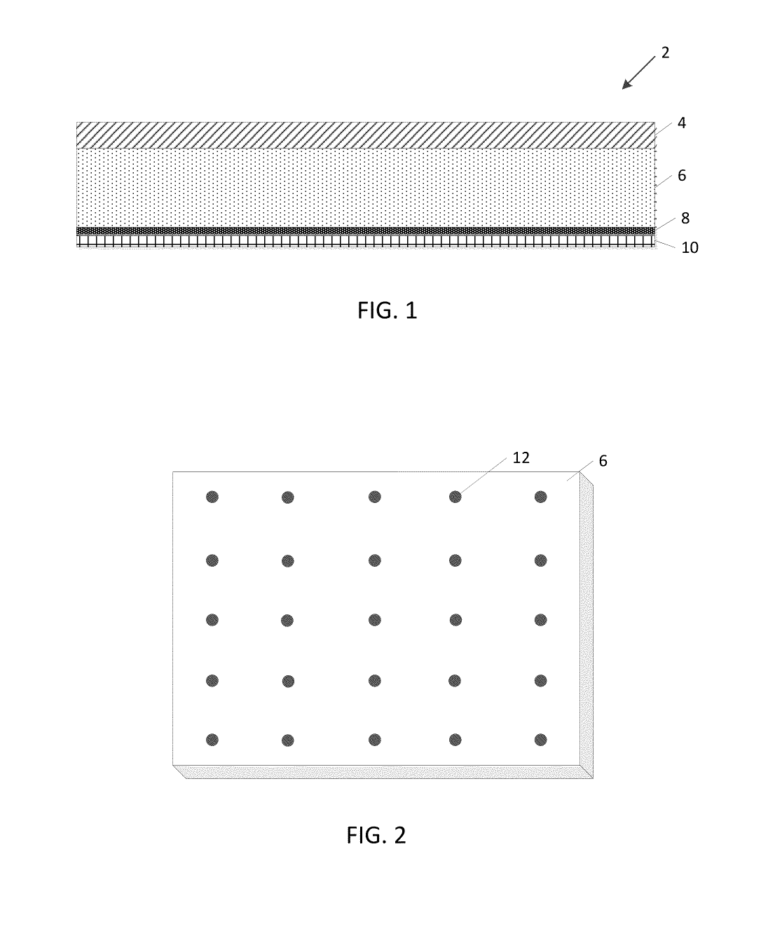

FIG. 1 shows a schematic cross-sectional view of a cushioned mat 2 according to one embodiment of the present invention. As shown in FIG. 1, the cushioned mat 2 is a layered structure comprising a top layer of face fabric 4, a foam layer 6, and a backing layer 10. In the illustrated embodiment, the cushioned mat 2 also includes a cloth layer 8 interposed between the foam layer 6 and the backing layer 10.

### Face Fabric

According to various embodiments, the face fabric 4 forms the top surface of the cushioned mat 2 and is configured for direct exposure to the elements. For example, in the illustrated embodiment of FIG. 1, the cushioned mat 2 is provided for use in a bathroom where it will be exposed to moisture and general wear and tear from daily use. Accordingly, in one embodiment, the face fabric 4 is formed from conventional fabric material, such as a knit polyester material. However, according to various embodiments, other fibers, such as cotton, can be used. In addition, the fabric may comprise conventional woven, chenille, or other constructions, may be formed in various weights (e.g., from 250-450 gsm), and may have various pile heights (e.g., from 3-40 mm).

In certain embodiments, the face fabric 4 may be formed from a high-absorbency fabric. However, various other materials can be used for the face fabric 4 and may be selected or pre-treated based on various factors, such as durability, softness, and anti-bacterial properties.

### Foam Layer

As shown in the illustrated embodiment of FIG. 1, the foam layer 6 is positioned underneath the face fabric 4. This configuration enhances the comfort of the user standing on the cushioned mat 2 by counteracting pressure from hard floor surfaces, such as those conventionally found in bathroom or kitchen facilities.

According to one embodiment, the foam layer 6 is comprised of open-cell viscoelastic polyurethane foam (i.e., memory foam). However, as will be appreciated from the description herein, the foam layer 6 can be formed from a variety of suitably compressible materials according to various other embodiments. In the illustrated embodiment of FIG. 1, the foam layer 6 has a thickness of approximately 15 mm and a density of approximately 50 kg/m². However, the thickness and density of the foam layer 6 may vary depending on intended use. For example, mats for use adjacent to bathroom or kitchen sinks may have more cushioning than mats used adjacent to a shower or bathtub due to the relative feel desired.

According to various embodiments, the open-cell construction of the foam comprising the foam layer 6 generally absorbs and retains water. Accordingly, to improve the drying properties of the cushioned mat 2, the foam layer 6 is apertured. FIG. 2 illustrates a top view of the foam layer 6. As shown in FIG. 2, the foam layer 6 includes a plurality of apertures 12 formed through the thickness of the foam layer 6. In the illustrated embodiment, the apertures 12 are each circular holes having a diameter of approximately 0.219 inches ( 7/32 in.) and are spaced in linear rows and columns approximately 1.75 inches apart from one another. In such an embodiment, there are approximately 49 of the apertures 12 per square foot of the foam layer 6 and the surface area of the apertures accounts for approximately 1.3% of the foam layer's total surface area.

According to various other embodiments, the apertures 12 may each have a diameter between, for example, 1 mm and 6 mm and may be provided with, for example, a density between 40 apertures per square foot and 1,600 apertures per square foot. In addition, the apertures 12 may be provided such that their collective surface area accounts for between 0.5% and 5% of the foam layer's total surface area. For example, in certain embodiments, the diameter of the apertures 12 are limited to a size that does not result in visible indentations on the face fabric 4, that provides sufficient strength across the foam layer 6 to support a user, and/or that provides sufficient ventilation of the foam layer 6. Accordingly, as will be appreciated from the description herein, the diameter of the apertures 12, the density of apertures 12 provided in the foam layer 6, and the percentage of the foam layer's total surface comprising the collective area of the apertures 12 may be selected based on strength, absorption, and/or aesthetic requirements of the cushioned mat 2.

In addition, as will be appreciated from the description herein, the apertures 12 may be provided in various diameters, arranged in various patterns, and provided in various concentrations in the foam layer 6. For example, in one embodiment, the apertures 12 may comprise a series of perforations. In addition, various embodiments of the apertures 12 may have different cross-sectional profiles (e.g., apertures having an ovular, rectangular, triangular, or x-shaped cross-section). In the illustrated embodiment of FIG. 2, the apertures 12 are vertically oriented and extend through the full thickness of the foam layer 6. However, in certain other embodiments, the apertures 12 may not extend entirely through the thickness of the foam layer 6 (e.g., apertures extending through a top surface of the foam layer 6 but not through a bottom surface of the foam layer 6). The apertures 12 may also be provided in other orientations, such as at an angle or extending horizontally through sidewalls of the foam layer 6. According to various embodiments, the apertures 12 may be formed in any suitable manner, such as by punching out portions of the foam layer 6.

In the illustrated embodiments of FIGS. 1 and 2, the foam layer 6 comprises a single layer of foam. However, in other embodiments, the foam layer 6 may be a composite of multiple foam layers. For example, foams of various densities and/or thicknesses may be secured together to produce various cushioning effects.

As shown in FIG. 1, the face fabric 4 is attached to an upper surface of the foam layer 6. In the illustrated embodiment, the face fabric 4 is laminated to the foam layer 6 using a polyurethane-based adhesive. However, in other embodiments, various other types of adhesives, including water-based adhesives, may be used for lamination. Alternatively, the face fabric 4 may be stitched to the foam layer 6, in addition to, or in lieu of, lamination.

### Cloth

As shown in FIG. 1, the cloth layer 8 is interposed between the foam layer 6 and the backing layer 10. In the illustrated embodiment, the cloth layer 8 comprises a jersey knit material formed of 40-50 denier polyester having a weight of approximately 40 gsm. However, according to various other embodiments, the cloth layer 8 may be formed of other fabrics, such as felt or other nonwoven fabrics.

In the illustrated embodiment, the cloth layer 8 is laminated to the foam layer 6 using an adhesive in order to provide a more effective bonding surface when attaching the backing layer 10. Therefore, depending on the relative bonding properties of the materials used, certain embodiments of the cushioning mat 2 may not have a layer of cloth interposed between the foam layer 6 and the backing layer 10. Furthermore, in certain embodiments, the cloth layer 8 may be laminated to the foam layer 6 before attaching the backing layer 10. In other embodiments, the foam layer 6 may be laminated to the cloth layer 8 and the backing layer 10 in one step.

### Backing Layer

As shown in FIG. 1, the backing layer 10 forms the bottom surface of the cushioned mat 2. In various embodiments, the backing layer 10 may be configured to provide resistance against slippage and to protect the foam layer 6 from abrasion and other damage (e.g., damage that might occur during regular use or washing of the cushioned mat).

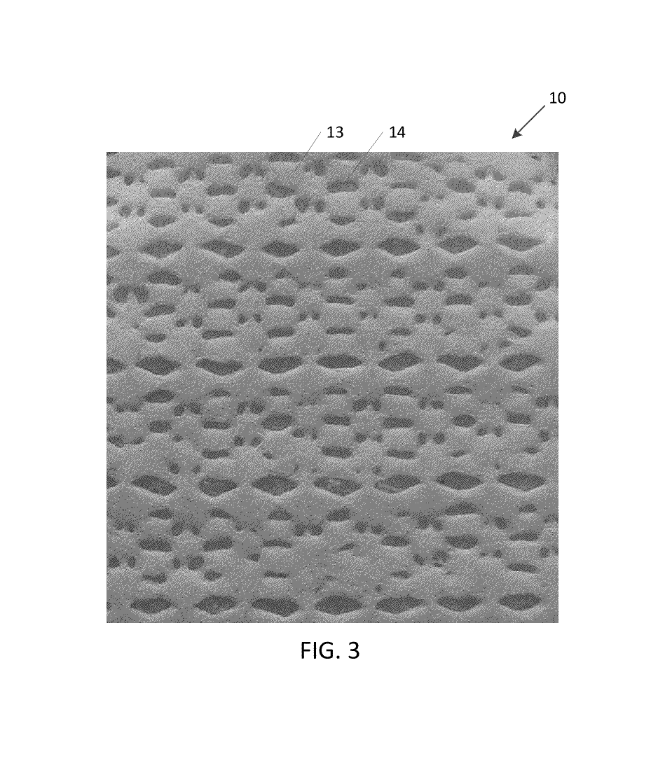

FIG. 3 shows a close-up view of a small section of the backing layer 10 according to an embodiment of the present invention. In the illustrated embodiment, the backing layer 10 is comprised of a loosely woven scrim 13 in which the filaments have been covered in a non-slip coating. The scrim 13 is woven from polyester fibers, and the non-slip coating is PVC. The backing layer 10 in this embodiment has a weight of approximately 180 gsm. However, in other embodiments, other materials may be used for either the scrim 13 or the non-slip coating. For example, in some embodiments, the non-slip coating may be formed from urethane. Further, depending on the parameters of the foam layer 6 (e.g., thickness, cell size, etc), other materials could be used for the backing layer 10 that provide a sufficient balance of porosity, abrasion protection, and anti-slip capabilities (e.g., non-woven materials, needle-punch fabric, knitted fabric, foam material).

In the illustrated embodiment of FIG. 3, the backing layer 10 is porous and, as such, the non-slip coating does not fully coat the surface of the scrim 13. Rather, the non-slip coating leaves openings 14 of various shapes and sizes spaced throughout the backing layer 10. As a result, water that has penetrated the foam layer 6, whether through normal use or washing, can leave the cushioning mat 2, such as by evaporation, at least partially through the openings 14 in the porous backing 10. Water may also leave the cushioning mat 2 through the face fabric 4.

The sizes of the openings 14 may vary in different embodiments depending on the density of the scrim 13 and the thickness of the non-slip coating. In the illustrated embodiment, the non-slip coating comprises approximately 60 percent of the surface of the porous backing layer 10, and the openings 14 comprise the remaining approximately 40 percent. In other embodiments, approximately 55-70 percent of the surface of the porous backing layer 10 may be comprised of the non-slip coating, with the openings 14 comprising the remaining surface percentage. Accordingly, in embodiments in which the backing layer 10 is porous, the openings 14 may comprise as much as 45 percent or as little as 30 percent of the backing layer surface. In various other embodiments, the backing layer 10 may be non-porous and comprised of any material having suitable abrasion resistance and anti-slip properties.

In the illustrated embodiment of FIG. 1, the backing layer 10 is attached to the cloth layer 8 after the cloth layer 8 has been laminated to the foam layer 6 opposite the face fabric 4. In this embodiment, the backing layer 10 is laminated to the cloth layer 8 and foam layer 6 using a polyurethane-based adhesive. However, in other embodiments, various other types of adhesives, including water-based adhesives, may be used.

According to various embodiments, the face fabric 4, foam layer 6, and the cloth layer 8 may first be stitched together, and then the backing layer 10 may be attached to the cloth layer 8. In certain embodiments, the backing layer 10 may be attached through the same lamination method described above in attaching the face fabric 4 to the foam layer 6. In various embodiments, the backing layer 10 may also be stitched to the other layers in addition to, or in lieu of, lamination. In various embodiments, the face fabric 4, the foam layer 6, and the backing layer 10 may be collectively stitched together in a quilted configuration. A quilted appearance or other pattern or design, such as a logo, may be provided by embossing the face fabric 4 and foam layer 6 through the application of heat and pressure. In other embodiments, the face fabric 4 and backing layer 10 may be bound together around the foam layer 6.

Once the backing layer 10 is attached, binding tape (not shown) may be sewn along the perimeter of the cushioning mat 2 to secure the face fabric 4, foam layer 6, the cloth 8, and the porous backing 10 in place. In embodiments without the cloth layer 8, the backing layer 10 may be attached directly to the foam layer 6. This attachment may be accomplished through conventional lamination or stitching methods.

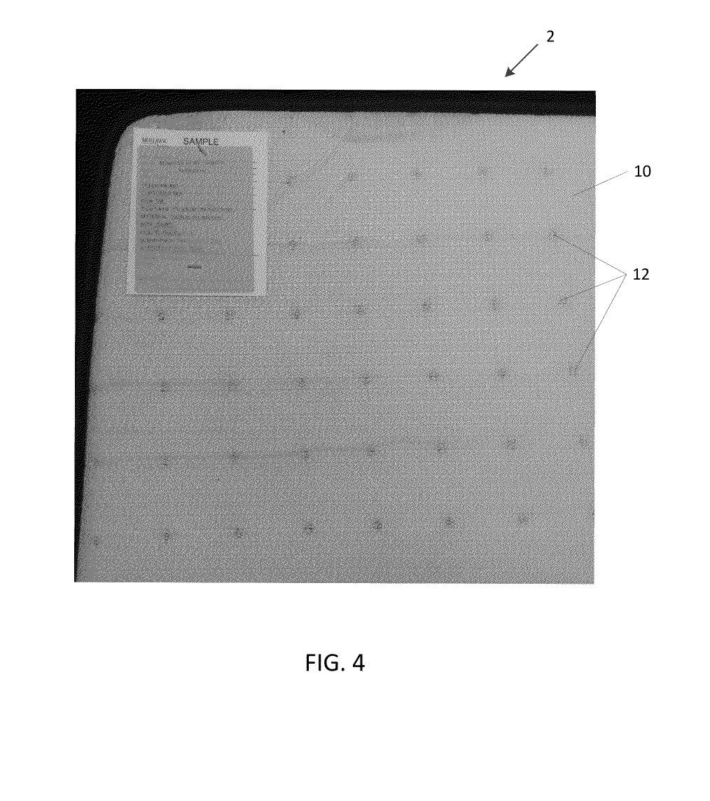

According to certain embodiments, the backing layer's openings 14 will align with the foam layer's apertures 12 when the backing layer 10 is secured to the cloth layer 8 (or directly to the foam layer 6). As a result, in air able to through the openings 14, the apertures 12, and the face fabric 4, thereby improving the breathability of the cushioned mat 2. For example, FIG. 4 shows a bottom view of a portion of the cushioned mat 2 according to one embodiment. As shown in FIG. 4, the apertures 12 in the foam layer 6 are visible through the backing layer 10 due to the backing layer's porous configuration.

In addition, certain embodiments of the cushioned mat 2 may not include a separate backing layer 10. For example, in one embodiment, the bottom surface of the foam layer 6 may be configured for be placed on a support surface (e.g., a floor). In such embodiments, the foam layer 6 may provide a non-slip surface to prevent the mat 2 from slipping on the support surface.

### Drying Performance of Cushioned Mat

As noted above, the cushioned mat's foam layer 6 generally absorbs and retains water due to its foam material's open-cell construction. Accordingly, in the illustrated embodiment of FIGS. 1 and 2, the foam layer 6 is apertured with a plurality of apertures 12 to improve the drying properties of the cushioned mat 2. As described in greater detail below, the apertures 12 in the foam layer 6 enhance the drying performance of the cushioned mat 2 in a various ways.

For example, users of the cushioned mat 2 may wish to periodically wash the mat, either by machine or by hand. In either method, the cushioned mat 2 will typically be saturated with water absorbed primarily by the mat's foam layer 6. Testing of the cushioned mat 2 has indicated that its apertured foam layer 6 will absorb less total water during washing and can be dried more quickly than mats having a non-apertured foam layer.

Table A and Table B shown below provide comparative test results for the washing and drying of cushioned mats having apertured and non-apertured foam layers. In particular, the tests resulting in the data shown in Table A were first conducted for a cushioned mat having a foam layer comprised of non-apertured memory foam (herein “the non-apertured mat”). This non-apertured mat was of the same type as the cushioned mat 2 described herein, with the exception of its non-apertured foam layer. The non-apertured mat was machine washed using a typical washing cycle and then dried in a machine dryer. The weight of the non-apertured mat was measured and recorded in ten minute intervals until the mat was completely dry (i.e., the weight of the mat was equivalent to its weight before washing). The results of this test are shown in Table A. The same process was then carried out for the cushioned mat 2 shown in FIGS. 1-3, which included the apertured foam layer 6 having the above-described apertures 12 (herein “the apertured mat”).

As shown in Table A, the non-apertured mat weighed 1.4 pounds before washing and weighed 2.65 pounds after washing, thus gaining 1.25 pounds of water weight. During drying, the non-apertured mat lost 0.35 pounds of weight after 30 minutes, 0.6 pounds after one hour, 0.85 pounds after one and a half hours, 1.0 pounds after two hours, 1.15 pounds after two and a half hours, and completed drying after two hours and 50 minutes.

As shown in Table B, the apertured mat weighed 1.2 pounds before washing and weighed 2.20 pounds after washing. Thus, the apertured mat gained one pound of water weight; 0.25 pounds less than the non-apertured mat. During drying, the apertured mat lost 0.4 pounds of weight after 30 minutes, 0.6 pounds after one hour, 0.75 pounds after one and a half hours, 0.9 pounds after two hours, and completed drying after two and a half hours. Thus, the apertured mated was able to dry completely 20 minutes faster than the non-apertured mat.

TABLE A
CUSHIONED MAT WITH NON-APERTURED
MEMORY FOAM LAYER

| Weight Before | Weight After | Elapsed | Weight After |
|---|---|---|---|
| Wash (LB) | Wash (LB) | Drying Time | Dry Cycle (LB) |
| 1.40 | 2.65 | 10 min. | 2.50 |
| | | 20 min. | 2.40 |
| | | 30 min. | 2.30 |
| | | 40 min. | 2.20 |
| | | 50 min. | 2.10 |
| | | 60 min. | 2.05 |
| | | 70 min. | 1.95 |
| | | 80 min. | 1.85 |
| | | 90 min. | 1.80 |
| | | 100 min. | 1.75 |
| | | 110 min. | 1.70 |
| | | 120 min. | 1.65 |
| | | 130 min. | 1.60 |
| | | 140 min. | 1.55 |
| | | 150 min. | 1.50 |
| | | 160 min. | 1.45 |
| | | 170 min. | 1.40 |

TABLE B
CUSHIONED MAT WITH APERTURED
MEMORY FOAM LAYER

| Weight Before | Weight After | Elapsed | Weight After |
|---|---|---|---|
| Wash (LB) | Wash (LB) | Drying Time | Dry Cycle (LB) |
| 1.20 | 2.20 | 10 min. | 2.05 |
| | | 20 min. | 1.90 |
| | | 30 min. | 1.80 |
| | | 40 min. | 1.75 |
| | | 50 min. | 1.70 |
| | | 60 min. | 1.60 |
| | | 70 min. | 1.55 |
| | | 80 min. | 1.50 |
| | | 90 min. | 1.45 |
| | | 100 min. | 1.35 |
| | | 110 min. | 1.35 |
| | | 120 min. | 1.30 |
| | | 130 min. | 1.25 |
| | | 140 min. | 1.25 |
| | | 150 min. | 1.20 |
| | | 160 min. | — |
| | | 170 min. | — |

In addition to having improved post-washing drying performance, the apertured cushioned mat 2 also provides enhanced performance during use. For example, when being used in a bathroom, the apertures 12 in the foam layer 6 allow air to flow more freely throughout the foam layer 6 and provide additional paths for water to evaporate from the foam layer 6 (e.g., through the face fabric 4 or through porous embodiments of the backing layer 10). In addition, as portions of the foam layer 6 compresses under loading from a user's foot and decompress as the user's foot is moved, water present in the foam layer 6 may be directed more easily out of foam layer 6 through the apertures 12 as the mat is compressed and decompressed. Thus, during use, the cushioned mat's apertured foam layer 6 enables the mat to dry more quickly in comparison to non-apertured embodiments (all other features remaining equal). This drying ability also helps to prevent the formation of mold and mildew in the mat during use.

### CONCLUSION

Many modifications and other embodiments of the present invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A cushioned mat configured for use as a standing surface in environments where water may come into contact with the cushioned mat, the cushioned mat comprising:
a face fabric configured for coming into contact with a user; and
an apertured foam layer secured to the face fabric, the apertured foam layer comprising a foam material having one or more apertures extending into the foam material.

2. The cushioned mat of claim 1, wherein the one or more apertures comprise one or more holes having a circular cross-section.

3. The cushioned mat of claim 2, wherein the one or more holes have a diameter between 1 mm and 6 mm.

4. The cushioned mat of claim 1, wherein each of the one or more apertures extends through the entire thickness of the apertured foam layer.

5. The cushioned mat of claim 1, wherein the one or more apertures are vertically oriented.

6. The cushioned mat of claim 1, wherein the one or more apertures comprise a plurality of apertures provided in a density between 40 apertures per square foot of the foam layer's surface area and 1,600 apertures per square foot of the foam layer's surface area.

7. The cushioned mat of claim 1, wherein the one or more apertures comprise punched portions of the foam layer.

8. The cushioned mat of claim 1, wherein the foam material comprises an open cell, viscoelastic foam material.

9. The cushioning mat of claim 1, wherein the open cell, viscoelastic foam material is viscoelastic polyurethane foam.

10. The cushioning mat of claim 1, further comprising:
a backing layer operatively secured to the face fabric layer and configured for reducing slippage of the cushioned mat against a support surface;
wherein the apertured foam layer is secured to and interposed between the face fabric and the backing layer.

11. The cushioning mat of claim 10, wherein the backing layer is formed with openings configured for allowing water in the foam layer to leave the mat at least partially through the openings in the backing.

12. The cushioning mat of claim 10, wherein the backing layer comprises a sheet of woven fibers coated with a slip-resistant substance.

13. The cushioning mat of claim 10, wherein the foam layer is bonded to the face fabric with an adhesive.

14. The cushioning mat of claim 10, wherein a cloth layer is interposed between the backing and the foam layer to promote bonding.

15. The cushioning mat of claim 14, wherein the cloth layer is bonded to the backing with an adhesive.

16. The cushioning mat of claim 14, wherein the cloth layer is laminated to the foam layer.

17. The cushioning mat of claim 10, wherein the face fabric, the foam layer, and the backing layer are collectively stitched together.

18. The cushioning mat of claim 17, wherein the face fabric, the foam layer, and the backing are collectively stitched together in a quilted configuration.
